(19) United States
(12) Patent Application Publication
(10) Pub. No.: US 2016/0001496 A1
(43) Pub. Date: Jan. 7, 2016

(54) Methods and apparatus for the fabrication of pattern arrays in making touch sensor panels

(71) Applicant: Preco, Inc., Somerset, WI (US)

(72) Inventors: Christopher Chow, Lake Elmo, MN (US); Daniel B. Miller, Roberts, WI (US); James J. Bucklew, Somerset, WI (US); Dana Poulain, De Soto, KS (US); Randy Schuster, New Richmond, WI (US); John T. Pierson, JR., Mission Hills, KS (US)

(21) Appl. No.: 14/755,724

(22) Filed: Jun. 30, 2015

Related U.S. Application Data
(60) Provisional application No. 62/039,606, filed on Aug. 20, 2014.
(60) Provisional application No. 62/019,696, filed on Jul. 1, 2014.

(51) Int. Cl. B29C 65/00; G06F 3/041

(52) U.S. Cl. CPC B29C 65/002; G06F 3/041; G06F 2203/04103; B29L 2031/723

(57) ABSTRACT

An electrically conductive touch sensor panel construction and method and laser system for fabricating the same. The transparent touch sensor panel comprises at least two conductive coatings to provide a drive layer and a sense layer. The drive and sense layers are laminated together or otherwise assembled in a touch panel construction and in selected alignment. The layers are then subsequently laser patterned to form the conductive pathways for the touch panel sensor. The drive and sense layers may be concurrently or sequentially laser processed to form a selected pattern in each layer such that the drive and sense layers are substantially aligned forming a far more precise pattern array for the panel.

### CROSS-REFERENCE TO RELATED APPLICATIONS

The present application is based on and claims the benefit of U.S. provisional patent application Ser. No. 62/019,696, filed Jul. 1, 2014 and U.S. provisional patent application Ser. No. 62/039,606, filed Aug. 20, 2014, the contents of which are hereby incorporated by reference in their entirety.

### FIELD OF THE INVENTION

This invention relates generally to the fabrication of touch sensor panels. More specifically, it relates to the methods and systems for the fabrication of the electrical pattern arrays for touch sensors made from silver nanowire coated conductive films. It offers novel techniques for processing larger touch panels with better sensor accuracy, improved registration of the conductive layers and fewer fabrication and processing steps and higher throughput.

### BACKGROUND OF THE INVENTION

A touch screen is an input device often used in conjunction with another functional device. For example, a transparent touch screen with an LCD panel placed behind it would become a touch display device. A user can perform various functions by touching the sensor surface using one or more fingers, styli or other objects at a specific location and/or in a specific manner The touch motion causes a change of signal in the sensor and is recognized by the computing system. The computing system will then, based on the touch event, respond with a set of instructions for the display panel. The new information on the display is perceived as outcomes performed by the user.

For both resistive and capacitive types of touch screen, this change comes from the changes in the electromagnetic signals generated from a set of micro-structured conductive cross patterns imbedded within the panel. These cross patterns must be aligned accurately with respect to each other in order for the touch sensor to perform well.

Resistive touch sensors had been commercially available for a number of years. However, capacitive touch devices with multi-touch capability and gesture functions have gained enormous popularity in consumer products since the introduction of the iPhone in 2007. Since then, the touch screen market has gone through explosive growth and become a double-digit billion-dollar industry today. The market further projects to triple in the next 10 years. Utilization of the device has expanded beyond mobile smart phones and tablets and has penetrated into PC notebooks, automotive touch displays as well as many sensing and gaming applications. By using film-based touch sensors, touch displays are lighter in weight, thinner in form factor and more flexible in shape. Sensors can now be fabricated in curved and other three-dimensional forms. Product demands are no longer limited to a smaller format.

Both resistive and capacitive touch panels rely on sensing the electrical output signal from an array of pixels formed by multiple drive lines (or patterns) in rows crossing over multiple sense lines (or patterns) in columns, where the drive and sense lines are conductive and are separated by a dielectric material. There are many ways to arrange the conductive layers in forming the arrays, and there are many configurations to assemble the sensor device. The specific design can affect the details of the fabrication steps. However, the general sensor configuration and working principle remain the same.

For example, FIGS. 1-3 illustrate a typical capacitive touch display and its inner construction. In FIG. 3, OCA refers to “optically clear adhesive” which is optically transparent and is used to bond various sheet components together. HC refers to “hard coat” scratch resistant film Routing electrodes are printed electrodes connected to the edges of the pattern arrays, for routing signals from the arrays to the IC board, when the line electrodes themselves do not have sufficient conductivity. FIG. 3 illustrates a panel configuration where the substrates are sandwiched between the conductive layers. While this may not be the most common configuration for a film based panel, it is commonly used for glass based panels. This configuration most easily illustrates the essential challenges relevant to capacitive touch displays of the present disclosure.

As illustrated in further detail in FIG. 4, the process outlined includes the typical processing steps used to construct a touch sensor panel as configured in FIG. 3 and to produce a sensor panel as shown in FIG. 1. The flow is suitable for sheet-to-sheet, sheet-to-roll or roll-to-roll film-based processing. The most important part of the entire process is in the creation and registration of the drive and sense line pairs. Often these patterns are required to align accurately with respect to each other with a dimensional tolerance better than approximately 75 microns or less throughout the entire touch surface in order to provide the best resolution and sensitivity for the sensor. A second important part of the process is to ensure that every processing step is clean and free of dust and debris, as these defects can be seen easily on a transparent sensor panel. What follows is a discussion of the process described in FIG. 4, with particular emphasis on some of the challenges facing the industry today.

The drive and sense patterns generally have different geometry and they are created by etching insulating paths onto an otherwise uniformly coated conductive layer. The commonly used conductive material is indium tin oxide (ITO). ITO is quite transparent and can be sputter-coated on a polymeric substrate such as polyester film. Annealing (heat treatment) of the ITO coated film is the first and the necessary step for the fabrication of the sensor for two important reasons. First, the conductivity of ITO increases and conduction variability reduces over the surface after annealing. Both factors are advantageous to the eventual signal detection from the pattern arrays. Second, the polyester substrate must be heat-treated to become dimensionally stable prior to the patterning process on the coated substrate. This is particularly important if the drive and sense arrays are processed separately before putting them together. The annealing time is long, upward to 2 hours.

Unfortunately, film shrinkage, though greatly reduced, is still observed when the film is subjected to the many processing steps after annealing. In addition, the shrinkage varies differently from lot to lot and from web to cross-web direction. To minimize the dimensional change from film shrinkage, it is advisable to produce the drive and sensor layers from the same lot of film-base material. When the drive and sensor layers are produced separately and the production is in large scale, tracing and matching production lots become a very difficult task.

Both wet and dry processes are available to image-wise etch onto the ITO conductive layer to form the insulation paths among the pattern arrays. Two wet etching processes are commonly used. The UV film/litho etch process gives fine pattern resolution and the emulsion etched process from screen printing offers higher throughput. FIG. 4 illustrates the screen printing process. The dry process uses UV, visible or IR laser to heat evaporate/ablate the ITO layer to form the insulating paths. Heat tends to lift the ITO at the melting edge and the ablative process generates ITO dust powders, which must be completely removed by air blowing or air suction.

After the sense or drive arrays are formed on the conductive layers, opaque routing electrodes are coated around the edge of the sensor area for routing electrical signals from the arrays to the IC board. They can be screen-printed silver ink or vapor deposited metal lines, or they may not be required at all if the drive and sense lines themselves are sufficiently conductive.

Methods of the prior art include, before the drive layer and the sense layer are laminated together, HC protective films first laminated to OCA and then punched with a die cutter to create a window opening for the output electrodes on the respective drive layer or sense layer. Laminating the patterned layer to the HC/OCA with the punched window requires good registration between the window opening and the location of the output electrodes. Current high-end die cutters with good vision registration can perform sufficiently well to meet the need.

Presently, the most difficult step in preparing a sensor is laminating the drive layer to the sense layer. Specifications for sensor devices call for registration between the corresponding pattern arrays to be within approximately 75 microns or less throughout the entire touch surface. For any reasonable sensor size larger than approximately 15 cm, this becomes a challenging task since the challenge in registration not only comes from the machine alignment accuracy within this lamination step, but also from the adjustment of the cumulative dimensional errors in both films resulting from the many processing steps prior to this lamination step. These errors can result from the imaging process during etching of the electrodes, shrinkage of the film during oven-drying after each of the two printing steps, and/or tension-induced stretch on the film during film transport and lamination. Regardless, whether using sheet-to-sheet, sheet-to-roll or roll-to-roll lamination, the fabrication process requires elimination of or accounting and correction for these errors. As the size of the sensor becomes larger, it becomes extremely difficult to meet the required specification if the drive and sensor layers are laminated late in the fabrication process.

The greater the number of processes and the more equipment involved in the process of forming the pattern, the greater the cumulative dimensional error. The more the two layers are processed separately, the more difficult it is to compensate for the errors when the layers are combined. In addition, the increase in the number of times a liner is removed before processing and a new liner re-applied after processing, the greater the chance the film has been exposed to dust and debris. Further, as the sensor surface size increases, so do the issues relating to dimensional error, making it much more difficult to form a debris-free panel. Presently, constant visual inspections are necessary to catch defects in time before costs escalate on rejects.

The ITO coated conductive material also presents other difficulties when the touch panel size increases. Higher conductivity is required for the layer such that the ITO coating must be greater in thickness. This not only reduces the optical transparency of the panel but also reduce the flexibility in handling the material as a thicker ITO layer is brittle and subjected to micro-crack during handling and the fabrication process. Several non-ITO films are being introduced that show more flexibility with equal or better conductivity. Notably, transparent conductive film coated from silver nano-wire networks are developed by Cambrios, 3M and a number of Japanese companies. The Cambrios Clear-Ohm film is solution coated and is scalable for wide web coating. The silver nanowires are coated with PMMA binder on polyester substrate.

### SUMMARY OF THE INVENTION

An aspect of the present disclosure relates to a method for making a touch screen panel. The touch screen panel is constructed prior to laser patterning the electrically conductive layers to form the electrically conductive array. Laser patterning of the touch screen panel may also be completed without removal of a protective liner. The method includes providing a first substrate having a conductive layer disposed on a first surface of the first substrate. The first substrate may be, for example, a polymer-based substrate. The first substrate may also have a first protective layer adhered to a second surface of the first substrate. The method further includes providing a second substrate having a conductive layer of on a first surface of the second substrate. The second substrate may also be a polymer-based substrate of construction similar to or different from the first substrate. The second substrate also has a second protective layer adhered to a second surface of the second substrate. The protective liner may also be a polymer based liner and of a composition different than the substrates.

Laminating the first and second substrates to each other with an insulating layer, requires the first and second substrates be adhered to each other on sides opposite from their first surfaces. Directing at least one laser beam to the laminated first and second substrates, the laser beam or beams having a wavelength that is transmissive to the first and second protective layers and to the first and second polymer-based substrates while being absorbed by the first and second conductive layers allows for the forming of an electrically conductive array. The array comprises corresponding conductive patterns in the first and second conductive layers. As the panel is constructed prior to laser patterning, the patterned array advantageously has increased alignment and registration.

Laser patterning a transparent touch sensor panel comprises laser patterning an integrally formed substrate having a first and second conductive layer. The first layer may be a drive layer and the second layer a sense layer where the drive and sense layers are in a fixed position with respect to one another. The integrally formed substrate is subsequently laser processed such that the laser is configured for selectively patterning an electrically conductive array by patterning both the drive and the sense layer. The laser patterning of the drive and sense layers may occur substantially simultaneously or may occur sequentially such that one layer is laser patterned with a laser set a selected wavelength and power and the second layer then patterned with the laser, wherein laser patterning one layer does not affect the conductivity or laser pattern of the other layer.

Another aspect of the present disclosure relates to a method of making a transparent touch sensor panel which comprises forming a substrate having at least one conductive layer disposed on a first surface, and the substrate further comprising a second conductive layer disposed on a second surface where the substrate compositionally comprises a first polymer. Adhering at least one protective layer onto at least a first surface of the substrate where the at least one protective layer compositionally comprises a second polymer allows the panel to be laser processed after construction. A laser beam or laser beams having a wavelength such that the absorption of the laser energy by the substrate is less than approximately 60% and the wavelength being absorbed by the at least one conductive layer is directed along a selected path on the panel. Directing the laser beam along the selected path selectively patterns the conductive layers for forming an electrically conductive array.

Laser processing a transparent touch panel construction comprising with one or more lasers requires the laser(s) to operate at selected laser wavelengths where the absorption of the laser energy by the substrate laminate is mild to moderate and less than approximately 60%. For example, the absorption of laser energy by the substrate may be in the range of approximately 25% to 60%. More preferably, the absorption of laser energy by the substrate may be in the range of approximately 35% to 50%. When two or more lasers are used for processing the touch panel construction, the lasers may be calibrated to the same standard and operating the lasers to form pattern arrays on the conductive layers sequentially or concurrently.

Yet another aspect of the present disclosure relates to an electrically conductive touch sensor panel construction for subsequent laser patterning wherein the panel construction comprises an integrally formed substrate having a first electrically conductive coating on a first surface and a second electrically conductive coating on a second surface, the second surface being opposite from the first surface. Each electrically conductive coating is applied directly to an opposing surface of the single substrate prior to laser processing the panel to form the touch sensor by patterning each conductive coating. In one embodiment, the electrically conductive layers comprise silver nanowires wherein laser processing selectively patterns the silver nanowires to form conductive pathways. The laser may also pattern the silver nanowires without ablating the wires along the laser path.

The transparent touch panel constructions and laser settings are configured such that the conductive layers are laser patterned to form the array after fabrication of the panel and may also be patterned without removal of protective liners Eliminating the removal and/or subsequent reapplication of the protective release liner reduces time and process steps required to fabricate a touch panel as well as reduces the time in which the coatings and panel itself may be exposed to debris, dust, fingerprints or other environmental contaminants.

The integrally formed substrate can be fabricated by selecting a first transparent polymeric film substrate wherein the first substrate is integrally formed with a drive layer thereon by coating a conductive layer directly onto said first substrate. Selecting a second transparent polymeric film substrate includes selecting a second substrate that is integrally formed with a sense layer thereon by coating a conductive layer onto said second substrate. These substrates are then laminated together, forming the integrally formed substrate such that the drive and sense layers are in a fixed position with respect to one another.

Yet another aspect of this disclosure relates to an embodiment where the integrally formed substrate can be fabricated by a substrate having a drive and sense layer on opposing sides or surfaces of the substrate. By selecting a transparent polymeric film substrate and integrally fabricating a first electrically conductive drive layer by coating an electrically conductive material on to a first surface of the film and a second electrically conductive drive layer by coating an electrically conductive material on to a second, opposing side of the film, the electrically conductive layers are in a fixed position with respect to one another prior to any laser patterning or processing.

The present disclosure relates to methods for improving registration and alignment between the sense and drive layers of a touch sensor panel wherein the conductive layers are laser patterned after fabrication of the sensor panel. Laser patterning both conductive coatings, wherein the conductive coatings are in a fixed orientation or position with respect to one another prior to laser patterning, whether laminated together or coated on to opposing sides of a single substrate, reduces the error associated with alignment of the coatings. This allows for a greater increase in the resulting registration of the conductive array, increasing the sensitivity of the touch panel. The method utilizes a laser system not requiring changing of settings to pattern each layer and further minimizes alignment and registration problems related to substrate shrinkage or warping prior to lamination and the prior art method problems including matching of the patterned layers when subsequently laminated together.

### DESCRIPTION OF THE DRAWINGS

FIG. 1 is a prior art view of the components of a touch display.

FIG. 2 is an illustration of the prior art construction of a capacitive touch sensor.

FIG. 3 is a cross sectional view of a prior art touch sensor.

FIG. 4 is a flow chart of the prior art process for fabricating a capacitive touch sensor.

FIG. 5 is a representation of the surface resistivity measured across the two sides of a laser scored line at various pulsed laser powers in a capacitive construction according the present disclosure.

FIG. 6 is an SEM (scanning electron microscope) sample illustrating the surface of the silver nanowire film after laser scoring at energy above the threshold for termination of silver nanowire conduction wherein the razor cut mark at the bottom was used as reference for the position of the score.

FIG. 7 is an image at 500× magnification of a sample from a transmitted optical microscope showing the laser score line and the remnants of the silver nanowires within the scoring path with a score line of 17 μm in width.

FIG. 8 is an SEM of sample surface after the silver nanowire film was scored with energy about 15× higher than the threshold energy for termination of a conductive path.

FIG. 9 is a flow chart illustrating the processing steps of capacitive touch sensors according to Example 1.

FIG. 10 is a cross sectional view of a layer construction of the touch sensor according to Example 1 wherein the HC PET/OCA layer of both sides are added after laser exposure as shown in the processing steps in FIG. 9.

FIG. 11 is a cross sectional view of a layer construction of the touch sensor according to Example 2.

FIG. 12 is a flow chart illustrating the processing steps of capacitive touch sensors according to Example 1.

FIG. 13 is a perspective view of a machine configuration of a raster scanning laser processing system.

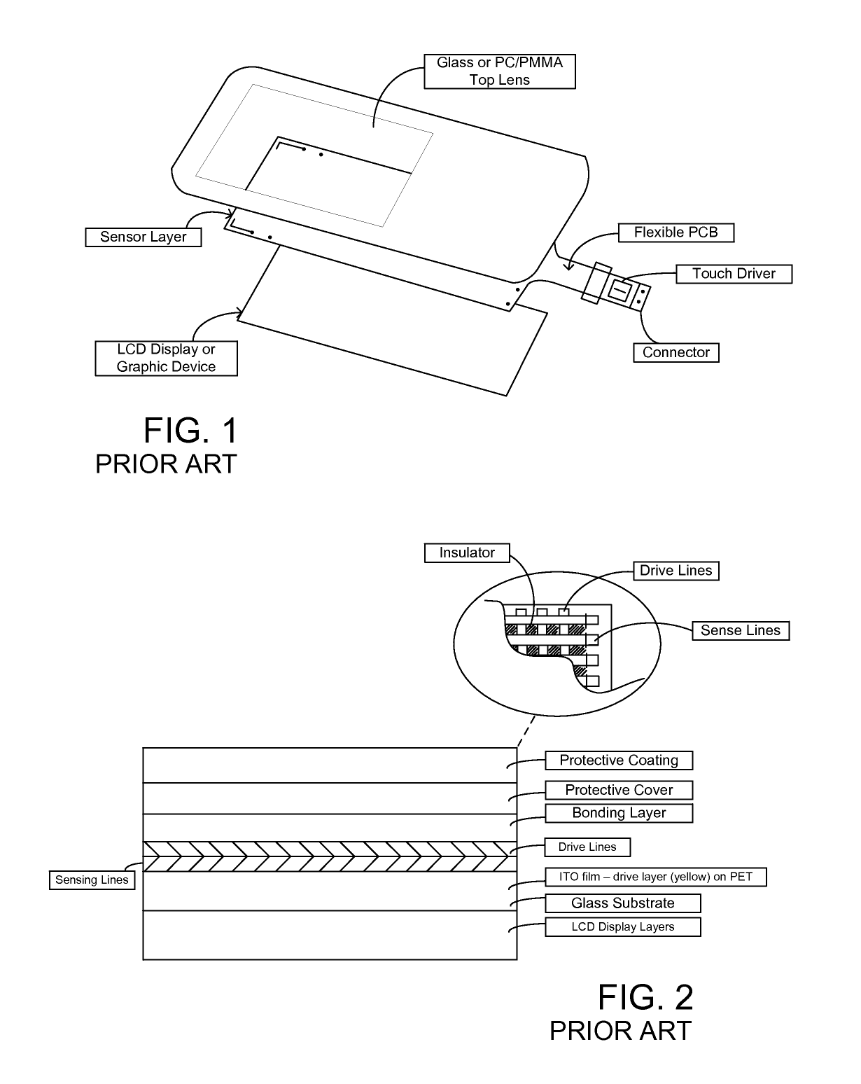

### DETAILED DESCRIPTION OF THE INVENTION

The present disclosure relates to a method and apparatus for making film-based flexible touch sensors. While applicable to any format size, the method and apparatus are particularly useful for making larger format panels. Laser patterning according to the methods and systems of the present invention is directed to integrally formed substrates having at least two conductive layers in a fixed position with respect to one another. These conductive layers, in fixed position with respect to one another, are then laser patterned. The conductive layers may be laser patterned either sequentially or concurrently. The present disclosure is thus directed to methods and systems for laser patterning touch sensors while eliminating the process steps, and reducing the error, associated with matching or aligning the patterned coatings for lamination and completing fabrication of the sensor.

In one embodiment, an electrically conductive touch sensor panel construction for use in a subsequent laser patterning process comprises an integrally formed substrate. By integrally formed, what is meant is that the substrate and its constituents are formed in contact with one another. At least one layer is positioned directly on another layer such that the panel comprises, for example, a sandwich configuration. For example, the integrally formed substrate may have a first and a second electrically conductive layer coated directly thereon wherein the first and second conductive coatings are directly adhered to opposing surfaces of the substrate prior to laser patterning. The panel comprises a first and second routing electrode, where the first routing electrode is in direct contact with the first conductive coating and the second routing electrode is in contact with the second conductive coating. A first and a second adhesive layer are also positioned such that the first adhesive layer is in direct contact with the first routing electrode and the second adhesive layer is in direct contact with the second routing electrode. Each of the adhesive layers may then be in contact with a hard coat protective layer and optionally, a protective liner may be adhered to each side of the panel.

When laser patterning this touch sensor panel construction, the first and second conductive coatings may be simultaneously laser processed by one or more laser beams to form an electrical pattern array. Alternatively, the first conductive coating may be laser processed and the second conductive coating may then be subsequently laser processed such that the first and second layers form an electrical pattern array.

When the first and second conductive coatings are simultaneously or subsequently laser processed to form corresponding electrical pattern arrays, the laser for laser processing may be configured to selectively terminate conductive paths of the conductive coatings without compromising the substrate. The panel construction may comprise conductive coatings comprising a silver nanowire conductive material and a binder.

Registration, or alignment, of the electrically conductive coatings and thus the laser patterned layers on each layer is greatly improved by laser processing the conductive layers after fabrication of the touch sensor panel. The methods include laser patterning the conductive layers sequentially or concurrently after the touch sensor layer construction has been completed. In the embodiment where a single film forms the integrated substrate, the integrated substrate is a single layer integrally formed rather than two or more substrate layers adhered to one another to form the integrally formed substrate.

Advantages of the methods of fabricating a touch panel according to the present disclosure include improved registration between the sense and drive layers as the layers are laser patterned together, rather than separately and later laminated together. Patterning the layers after lamination also reduces the issues associated with matching the layers when laminating the layers, as the layers can be laser patterned after lamination or fabrication. By laser patterning both conductive coatings after fabrication, the laser settings for the substrate are constant and the coatings can be laser patterned simultaneously or sequentially. These methods eliminate problems related to substrate distortion, shrinkage or warping and introduction of debris due to prior art fabrication methods.

Sensor panels according to the present disclosure comprise a drive layer and a sense layer, each layer being laser patterned. The layers are aligned to form a capacitive touch sensor panel. The patterns of the drive and sense conductive layers are required to align accurately with respect to one another, with a dimensional tolerance better than approximately 75 microns or less throughout the entire touch surface in order to provide the best resolution and sensitivity for the sensor. Simultaneously processing the drive and sense layers results in greatly improved alignment of the drive and sense layers and simplifies the laser patterning process by requiring consistent laser power and wavelength settings.

Processing the conductive layers sequentially may require a fiducial, or aperture, that is punched into the laminate construction. The fiducial is used for alignment and laser patterning of both sides. One or multiple fiducials or other markings may be used in laser patterning conductive layers to further aid in alignment and registration. The conductive array formed by methods disclosed herein is far more aligned than the panels of the prior art and further, registration is improved such that the pattern of each conductive layer can be in substantially complete registration providing for a more sensitive and precise touch sensor.

It is also important to ensure that every processing step is clean and free of dust and debris, as these defects can be seen easily on a transparent sensor panel. An additional advantage of the methods and systems of the present disclosure include a reduction in the exposure of the substrates and patterned layers to debris and other environmental contaminants. The conductive layers can be laser processed or patterned concurrently, and additionally, without removal of a protective release liner. The protective release liner would generally be removed prior to processing and subsequently reapplied, however the methods and systems described herein reduce the exposure of the coatings and substrate to debris, dust, fingerprints or other environmental contaminants, thus eliminating the need for a release liner. This includes eliminating the liner application or removal before or after each respective step in the process of fabricating a touch sensor.

A laser processing apparatus and corresponding methods allow the conductive layers to be patterned without removal of the protective liner. What is meant by the term “liner” or “protective liner” as used interchangeably throughout this disclosure is a removable or release liner, typically comprised of a flexible polymer which is adhered to and on top of a substrate or on top of a protective hard coat on the substrate. The liner is typically left on, covering the substrate or work piece to protect the substrate from oils, lubricants, residual coatings, dust or other environmental contaminants. The liner is generally removed by peeling off the liner back onto itself or otherwise separating the liner from the substrate after fabrication or installation of the substrate.

The capacitive touch sensor panel of the present disclosure can be most easily described in a discussion of several sets of experimental observations. These experimental observations were made during a study of the interactions of a Cambrios silver nanowire film with laser light. It should be noted that the methods and apparatuses of this disclosure may be utilized with various substrates and/or alternative conductive coatings, layers or substrates including conductive inks including other silver nanowire inks, conductive metal inks or coatings, graphene layers or coatings, carbon nanotube layers or coatings and other materials having conductive properties. Further, the laser power settings may be adjusted based on the specific conductive coating or substrates used.

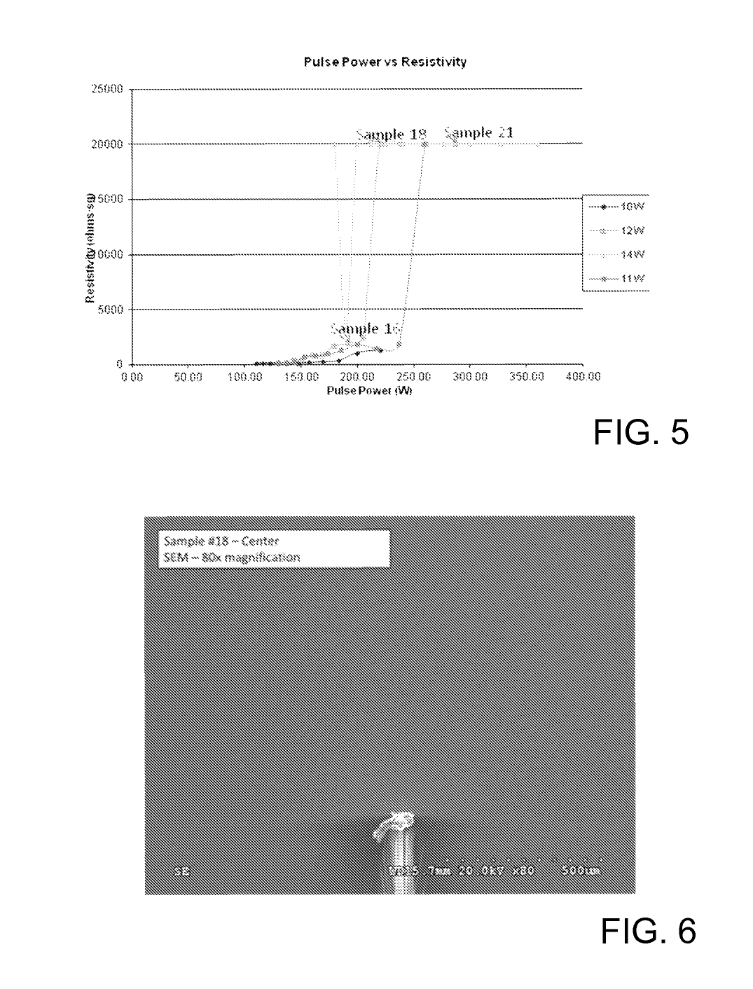

From the examples discussed further below, it has been discovered that the onset threshold for terminating a conductive path, for example, a silver nanowire conductive path, within the film is relatively sharp. The average laser power required for creating the insulation path is low. Referring to FIG. 5, which illustrates the surface resistivity measured across the two sides of the laser scored line vs. various pulsed laser powers, a typical electrical resistive response of the film under laser power is seen. The reduction in conductivity of the nanowires as measured in ohms per square over the laser exposed line is very abrupt. Within an approximately 20% change in laser power, the conductive line irreversibly switched from an ON state to an OFF state. This “step function” characteristic allows creating an imaging spot as “pixel” on the film with a definitive and maximum non-conductive value.

As more pixels are made and allowed to overlap, the resistive value of the overlapping portion of the pixel and the non-overlapping portion of the pixel remains consistent. Thus, patterning on the film is a digital binary printing process. The sharper the step, the wider the laser operating window. The faster the addressing rate, the faster the processing speed. The total average power and peak power required for the laser are small, and well within the reach of commercially available fiber lasers, diode lasers or semiconductor lasers.

It was also discovered that the response of the silver nanowire coatings or films to laser exposure is similar over a broad range of laser wavelengths (e.g. from UV to near IR). Laser exposure of the silver nanowire coated film was tested with several lasers having wavelengths in the range between approximate 355 nm to 1060 nm. The “step-function” response of the silver nanowire film to the laser wavelengths was very similar and the required laser power was low. Laser patterning silver nanowire coatings according to the methods and system of the present disclosure results in terminating the conductive paths selectively, but the silver nanowires are not ablated, or melted. It was not until the laser power was increased to at least 10× to 50× higher, the commonly resulting ablative or heating effects during material processing were observed. This conductive termination process results over a broad range of laser wavelengths.

Laser processing silver nanowire film according to the present disclosure includes selecting a laser wavelength based on considerations including, but not limited to matching, for example, the characteristic of the substrate polymer or other additives added to the polymer.

### EXAMPLE 1

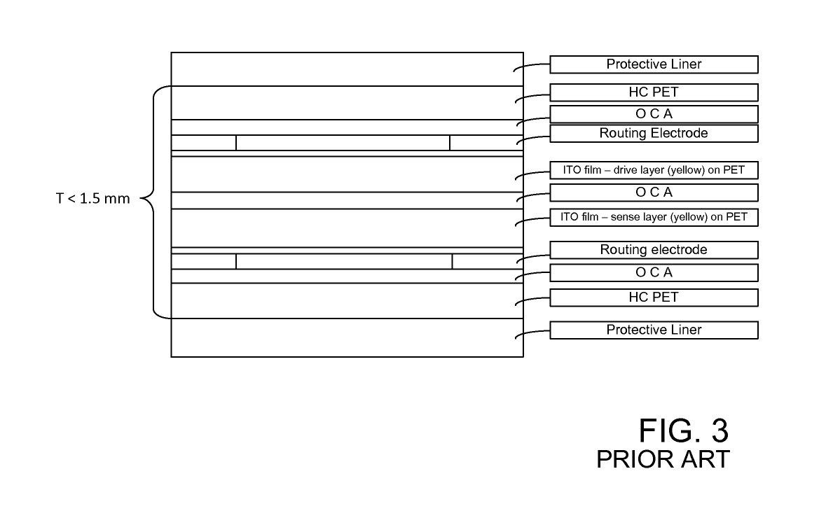

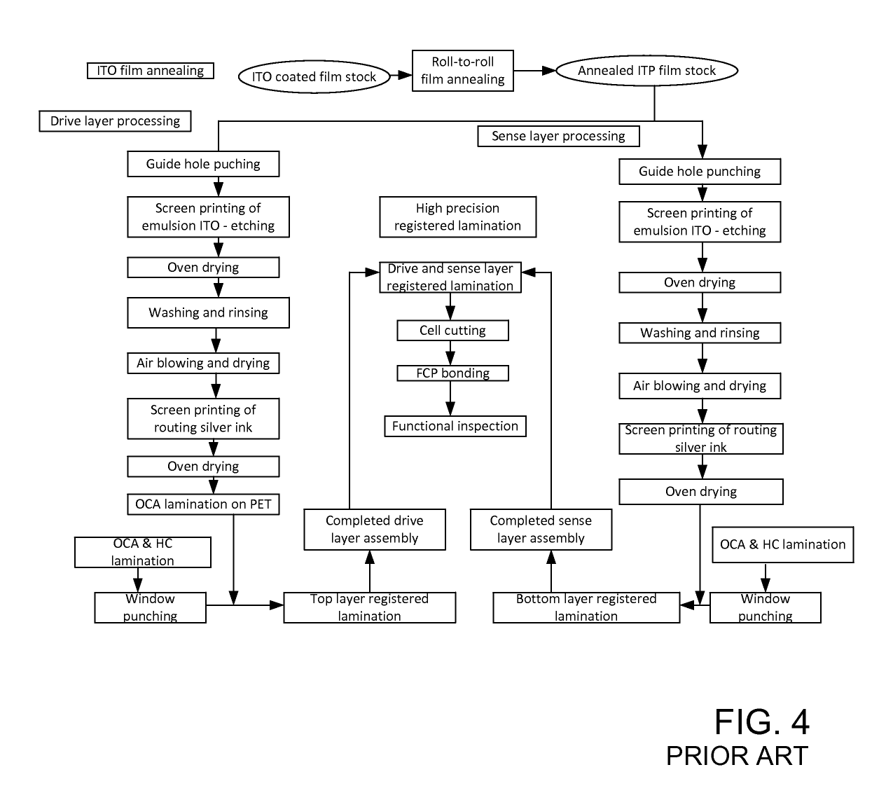

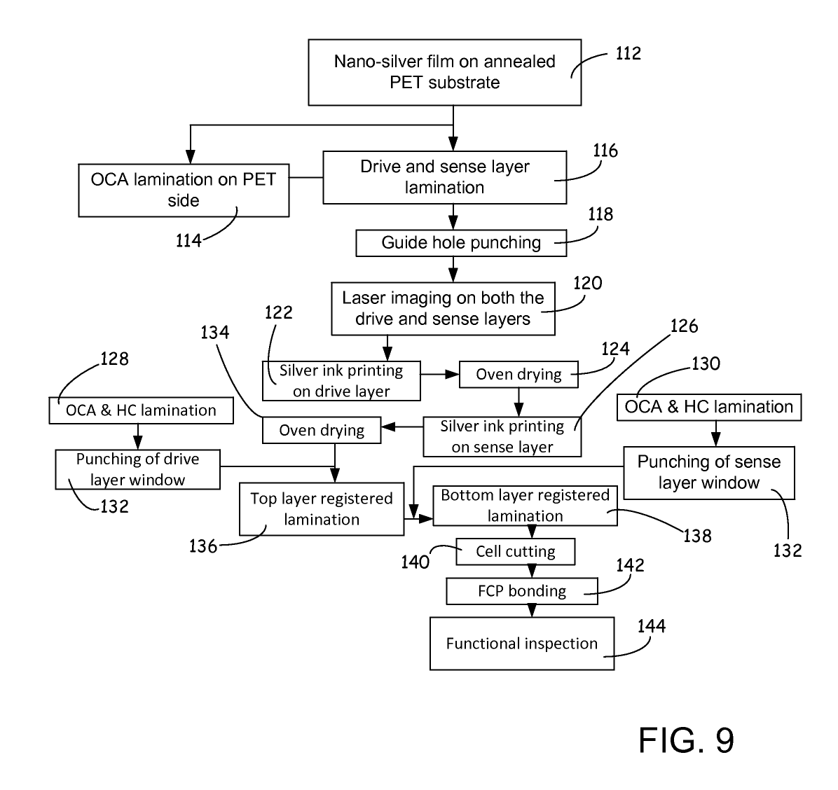

A touch panel 100 made from silver nanowire conductors having a layer construction as illustrated in FIG. 9 may be fabricated by the method of the present disclosure. The panel construction is similar to the construction illustrated in FIG. 3, except the conductive coatings are instead conductive coatings comprising silver nanowires (in contrast to ITO). In this example, the silver nanowires are solution-coated with PMMA (Polymethylmethacrylate (Acrylic)) binder. Typical binder thickness is approximately 6 μm. The substrate is PET (Polyethylene Terephthalate), having typical substrate thickness of approximately 100 μm. The conductive layers may be separated by an insulator, for example, an insulting layer such as a substrate or an adhesive layer in order for the electrically conductive array to function as a touch sensor.

The method of fabricating the laminate construction, or touch sensor panel, according to the present disclosure is distinct over the prior art processes and associated steps illustrated in FIG. 3. As illustrated in further detail in FIG. 9, the process may include steps 112 to 144 and distinct steps of the method include:

(112) PET film may be annealed first before being solution-coated with silver nano-wire networks Unlike ITO coating, a nano-silver coating does not require post-annealing to enhance conductivity and durability. Annealing conditions include exposing the film to approximately 155° C. for approximately 45-60 minutes with the PET roll to roll having low film tension.

(116) PET substrate to be processed as the drive layer (PET coated with silver nanowire solution) and PET substrate to be processed as the sense layer (PET coating with silver nanowire solution) are first laminated to one another, before forming electrical pattern arrays on the layers by laser patterning. Once laminated, the conductive layers are in a fixed position with respect to one another, and fiducials are spaced and punched 118 on the laminate to serve as common registration marks for the subsequent patterning process.

(120) Pattern arrays are formed by using a near IR laser. For example, a Ho:YAG diode laser operated at approximately 2.15 microns can be used.

(134, 136) Laminated sample is placed on a precision X-Y table. The laser scanning is controlled by a XYZ galvanometer scanner system. Vision registration to the fiducials provides accurate placement of the scanning lines to form the pattern arrays. The sample is stepped and repeated by the X-Y table to achieve a large patterning area. The process is repeated on the opposite side of the conductive layer, so that both conductive silver nanowire coatings are laser patterned and aligned with one another. Same fiducials are used for vision registration. Registration accuracy of the pattern arrays between the two layers is within approximately 70 microns over a surface area of approximately 35 cm diagonal.

The laser wavelength selected is such that the present PET/OCA/PET (wherein “OCA” refers to an “optically clear adhesive”) laminate provides approximately 25% to 30% attenuation of the laser power. Specifically, for the present layer construction, the PMMA binder is approximately 99.5% transparent at the laser wavelength and the PET/OCA/PET laminate is approximately 70% transparent. As the laser forms patterns on one side of the nanosilver conductor, the laminate provides enough attenuation of the laser power to be below the threshold power necessary to terminate the conduction of the nanosilver wires on the opposite side of the laminate.

The laser power density is actually further reduced by secondary effects from multiple surface reflections between the film layers and the defocusing of the laser beam on the opposite side of the laminate.

This method allows lamination, and fixed positioning of the conductive layers with respect to one another, to be completed before laser patterning by selecting a laser wavelength at which the binder is essentially transparent and the substrate(s) has only mild to moderate laser absorption. The cumulative heat absorbed within the substrate layer is below the glass transition temperature of the polymer. At the same time, the transmitted laser energy to the opposite side of the film is no more than approximately 70%. Further, the threshold laser energy for terminating the conductive path is far below the threshold energy for damaging the polymer optically.

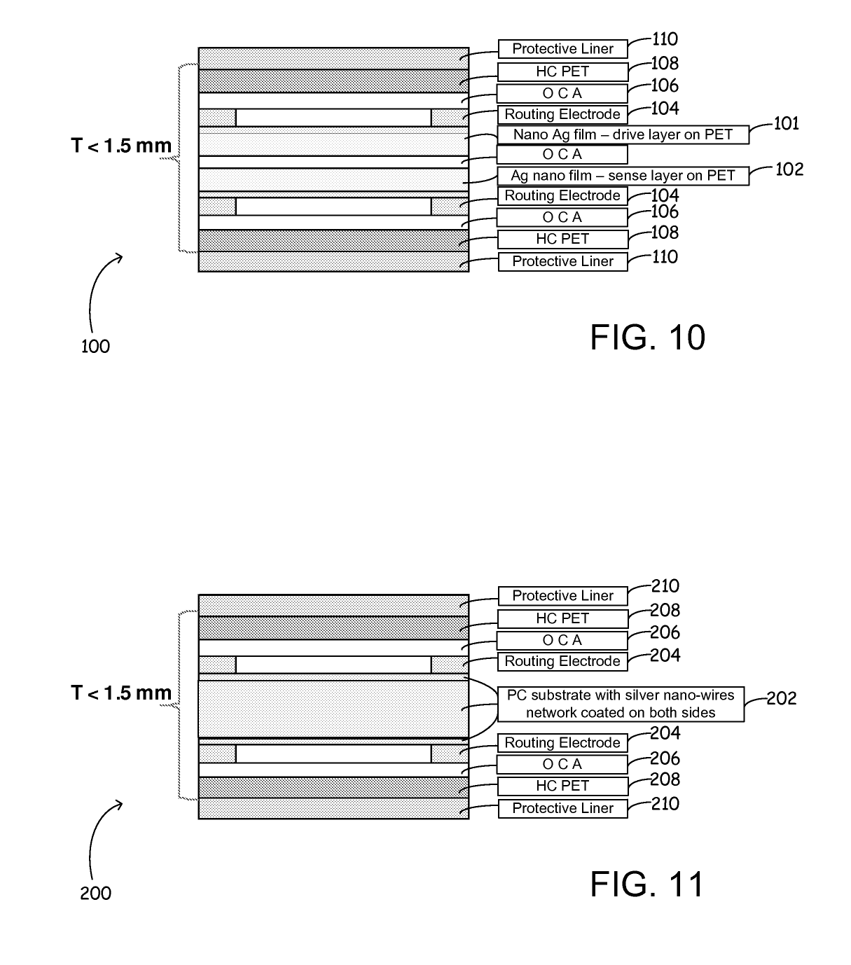

Illustrated in FIG. 10 is the construction of the touch sensor 100, by layer, per the description of Example 1. The HC PET/OCA (wherein “HC” refers to “hard coat”) layer of both sides are added after laser exposure as shown in FIG. 9, which illustrates the processing steps of the capacitive touch sensors of Example 1. The silver nanowire drive layer 101 is coated on PET and the silver nanowire coated sense layer 102 is also coated on PET where the layers are laminated with a layer of OCA 106. Routing electrodes 104, a layer of OCA 106 and HC PET 108 are layered sequentially where in each side of the construction may then comprise a protective liner 110.

The substrate film material of the construction according to Example 1 has an absorption coefficient in the range of approximately 5 cm⁻¹ to 100 cm⁻¹ at the specified laser wavelength. For a normal transparent touch panel with film thickness in the range between approximately 100 μm to 500 μm, the absorption coefficient of approximately 10 cm⁻¹ to 70 cm⁻¹ is preferred. In Example 1 a 2.15 μm laser was used, indicating that substrates including but not limited to PMMA, PVC (Polyvinyl Chloride) and PC (Polycarbonate) at suitable film thicknesses can be used as a substitute as well as PET. The choice of substrate may depend on the specific end application.

The laser should match the specified substrate laminate to provide an overall absorption greater than approximately 25%, and preferably in the range between approximately 30% to 50%. A 2.15 μm laser is not the only a suitable laser for PET, PMMA or PC as substrate. For example, a thulium laser at approximately 1.91 μm may also be used for thicker films, and a thulium doped fluoride laser at approximately 2.25 μm to 2.5 μm may be used for thinner films. Yb doped fiber lasers or other tunable solid state lasers from approximately 1.67 μm to 2.46 μm may also be used according to the methods of the present invention.

As tunable near- to mid-IR lasers become readily available, there are many possibilities for matching the laser with a specific substrate and laminate. Spectral broadening of polymeric films is common in commercially available polymeric films and the absorption curve may alter or broaden from one vendor to the other.

### EXAMPLE 2

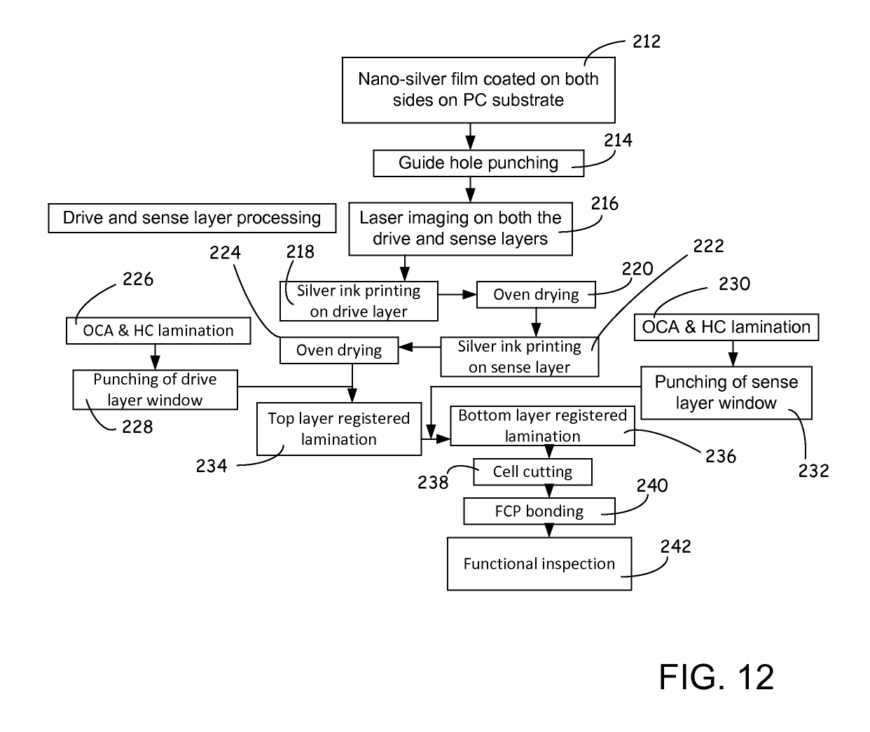

A touch panel 200 made from silver nanowires conductors having a layer construction as illustrated in further detail in FIG. 11 may be fabricated as follows: the silver nanowires are spin-coated with PMMA binder sequentially onto both sides of a 400 μm PC substrate. The PMMA binder has a thickness of approximately 6 μm. A 2.15 μm laser can be used for patterning the electrical arrays on both conductive coatings, on both sides of the substrate. For a double-side coated substrate, no lamination is necessary before laser patterning the conductive layers as once each layer is coated onto a respective, opposing side of a substrate, the layers are in a fixed orientation with respect to one another. FIG. 12 illustrates these simplified processing steps. Processing steps 212 to 242 are illustrated in FIG. 12 and include, for example, coating the nanowire silver film on to both sides of a PC substrate 212; laser imaging on both the drive and sense layers 216, printing a silver ink on the drive layer 218 and the sense layer 222, laminating the top layer in registration with the bottom layer 234 and laminating the bottom layer in registration 236, cell cutting 238 and FPC bonding 240. The resulting panel can easily be made in a large format, up to 35 cm when measured on the diagonal or molded into a three-dimensional shape.

Examples 1 and 2 illustrate that, given the present disclosure, the interactions of silver nanowires with visible to IR lasers, there are many ways to consider the absorption characteristics of the substrate(s) such that the drive and the sensor layers can be placed together, secured together or laminated, before the laser patterning process begins. With proper consideration, optionally one can consider coating an IR absorbing layer or coating on the substrate as an optical absorber for a laser that otherwise is too transparent for the substrate. For example, PET is substantially transparent to the 0.85 μm diode laser. By coating absorbing dyes on PET or incorporating it as a laminating layer in the laminate, it can result in the proper absorption for the laser, allowing for processing as discussed throughout this disclosure. IR adsorbing dyes that are transparent in the visible range such as Clear Weld or others used in the display and imaging industry are commercially available.

The panel thus comprises a sandwich-like construction as illustrated in FIG. 11. A PC substrate with silver nanowire network coated onto both opposing surface sides 202 is formed with routing electrodes 204 on the surface of each silver nanowire network coating. An optically clear adhesive 206 (OCA) is applied between each routing electrode layer 204 and the HC PET 208. A protective liner 210 then may be applied to outer surfaces of the panel construction. The overall thickness T of the panel may be equal to or less than approximately 1.5 mm.

### EXAMPLE 3

A silver nanowire coated PET film is normally received with a 50 μm thick PE (Polyethylene) release liner on top to protect the coating surface. By providing better intimate contact between the release liner and the film and by placing the film under a scanning 1.04 μm laser without removing the liner, terminating score lines were formed on the conducting layer, similar to lines obtained when processing with the protective liner removed. Upon removing the liner after imaging, no smoke, debris or other damages were observed on the film surface after visual inspection under a microscope at 90× power. Unlike the conventional patterning methods with generally include litho/etch wet processes or laser ablating/evaporation processes where the liner must be removed, the current laser patterning process can be conducted without the removal of the protective liner. No post cleaning step nor application of new protective liner is required. In Examples 1 and 2 wherein a 2.15 μm laser may be used; either 25 μm PE or PP (Polypropylene) liner would be adequate for the laser exposure process.

Laser apparatuses suitable of processing the touch panels are available commercially. Preco Inc., an industrial laser system provider and service contract manufacturer, has a series of three systems for use. Example 1 utilizes a Preco FlexPro laser system with vision registration. The system combines the speed of galvanometer processing with a tight tolerance XY motion table to produce scalable touch panel from approximately 10 cm diagonal to 160 cm diagonal. Preco also offers a high throughput narrow web roll-to-roll laser processing system and a wide web roll-to-roll FlexStar laser processing system. All these three systems process graphic files in vector format. A large graphic file is divided into cells to fit within the field of view of the galvanometer to be processed and eventually stitched back together to form the large pattern.

It should be further noted that an example of a suitable laser for use according to this invention disclosure includes, but is not limited to, a fiber laser, solid-state laser, semiconductor laser, ceramic laser, quantum cascade laser, super continuum laser or parametric oscillating tunable laser. Further, the substrates or transparent films referred to throughout this disclosure may include, but are not limited to PET, PC, PP, PMMA, PVC, PS (Polystyrene), PA (Polyamide), PU (Polyurethane), PE, Nylon 66 or a combination thereof.

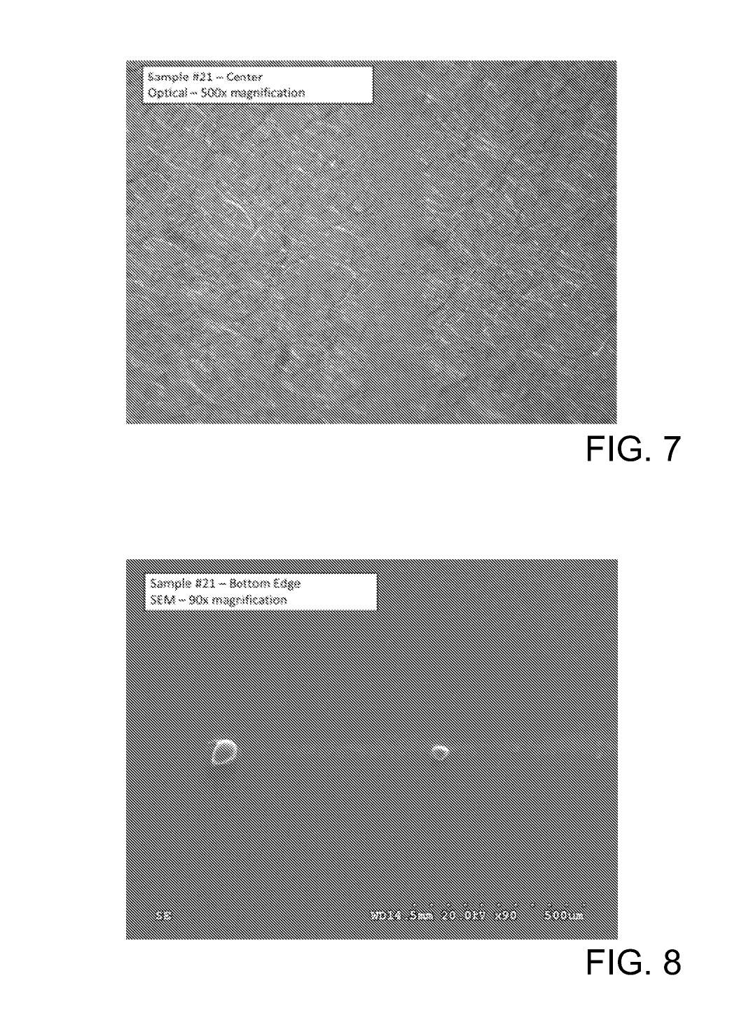

With respect to the present disclosure, the laser energy level that causes the termination of the conductive path on the silver nanowire film is far below the visible damaging threshold for most polymeric films, at least in the range from visible to approximately 2.5 μm wavelength and up to approximately 5 μm. The substrates can thus withstand laser patterning of the silver nanowire conductive layers without damage to the substrate, the surface of the binder polymer, or to the interior of the binder and the substrate. This occurred also when the laser was set at approximately 30% higher than the threshold power level as illustrated in FIGS. 6-8 wherein laser score line and remnants of the silver nanowires can be seen according to various laser processing settings.

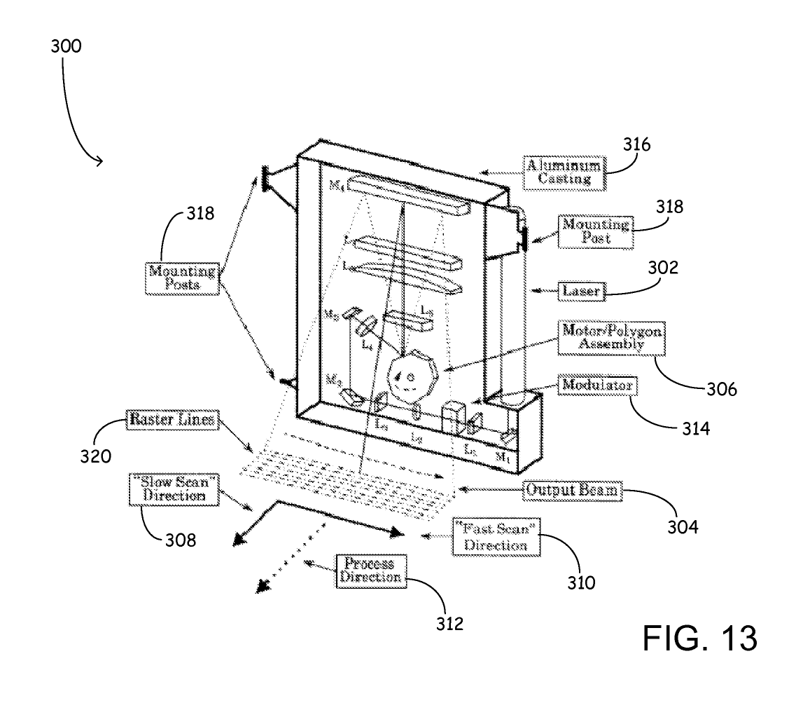

Referring now to FIG. 13, which illustrates a printer schematic 300, a graphical pattern to be laser processed can be first rasterized into bit maps stored in a computing memory and later patterned by a printing technique. The imaging system consists of a laser 302 that generates an intensity-modulated beam 304 that through a set of flat-field lens arrangement, focuses into a focus spot on the transparent conductive medium. A motor and polygon mirror assembly 306 allows the mirror assembly to raster-scan the focusing spot over the transparent conductive medium in one of a “slow scan direction” 308 which is a direction parallel to the process direction 312 or a “fast scan direction” 310 which is a direction transverse to the process direction 312 while the laser is intensity-modulated (by modulator 314) with pixilated spots along raster lines 320 responding to the negative of the desired conductive pattern. The printer assembly may further comprise a housing 316 and mounting posts 318 which allows the system to be positioned proximate a substrate for laser patterning.

While the polygon translates the focused beam along the “fast scan” direction, the laminate itself is translated in the “slow scan” direction transverse to and in synchronization with the “fast scan” axis. The conductive material is therefore processed continuously while it is being transported. The resulting throughput from such a system would match or exceed current available laser systems for fabrication of touch panels. Since the drive and sense conductive layers are laminated, the system can be further configured to have two lasers to sequentially or concurrently process on both sides to double the throughput. Furthermore, since the entire equipment and the lasers are calibrated together and the imaging steps are performed at the same time at the same environment, it offers the best possible conditions for accurate registration of the corresponding patterns between the drive and the sense layers. Without the removal of liners before processing, the system offers a dry and clean process that improves product accuracy, throughput and yield.

This disclosure addresses methods and systems for fabricating touch sensor panels including laser patterning and pairing electro patterns on conductive surfaces made from silver nanowire networks. While specifically directed to the fabrication of transparent touch sensor panels with higher accuracy, larger formats, better throughput and higher yields, the methods and systems described herein apply equally well to the fabrication of non-transparent touch panels as well as additional sensor and display applications including electroluminescence and OLED displays.

Although the present invention has been described with reference to preferred embodiments, workers skilled in the art will recognize that changes may be made in foam and detail without departing from the spirit and scope of the invention.

What is claimed is:

1. A method for making a touch screen panel, the method comprising:
providing a first substrate having a conductive layer disposed on a first surface of the first substrate, the first substrate being a polymer-based substrate and the first substrate having a first protective layer adhered to a second surface of the first substrate;
providing a second substrate having a conductive layer disposed on a first surface of the second substrate, the second substrate being a polymer-based substrate and the second substrate having a second protective layer adhered to a second surface of the second substrate;
laminating the first and second substrates to each other with an insulating layer therebetween, where the first and second substrates are adhered to each other on sides opposite from their first surfaces; and
directing at least one laser beam to the laminated first and second substrates, the laser beams having a wavelength that is transmissive to the first and second protective layers and to the first and second polymer-based substrate while being absorbed by the first and second conductive layers to form a corresponding conductive pattern array in the first and second conductive layers and wherein the array is aligned and having substantially complete registration.

2. The method of claim 1 and the at least one laser beam having a selected laser wavelength such that the absorption of the laser energy by the substrates is less than approximately 60%.

3. The method of claim 1, wherein the absorption of the laser energy by the substrates is preferably in the range from approximately 25% to 60%.

4. The method of claim 1, wherein the absorption of the laser energy by the substrates is preferably in the range from approximately 30% to 50%.

5. The method of claim 1, and further comprising two lasers wherein the two lasers are calibrated to the same standard and operating the lasers to form pattern arrays on the conductive layers sequentially.

6. The method of claim 1, and further comprising two lasers wherein said two lasers are calibrated to the same standard and operating the lasers to form pattern arrays on the conductive layers concurrently.

7. The method of claim 1, wherein said laser processes the panel without removing a top layer protective liner.

8. The method of claim 1, wherein the conductive layers comprise a silver nanowire conductive material and a binder.

9. The method of claim 1, and further comprising the step of punching at least one fiducial in the laminated substrates for visual registration of the panel to ensure accurate placement of scanning lines for directing the laser beam for laser patterning.

10. The method of claim 1, and further comprising repeating the pattern array in a stepped area to process an area up to approximately 35 cm measured on the diagonal to form the touch screen panel.

12. The method of claim 1, wherein laminating the conductive layers comprises applying a transparent adhesive.

13. A method of making a transparent touch sensor panel, the method comprising:
forming a substrate having at least one conductive layer disposed on a first surface, and the substrate further comprising a second conductive layer disposed on a second surface; the substrate comprising a first polymer;
adhering at least one protective layer onto at least a first surface of the substrate, the at least one protective layer compositionally comprising a second polymer; and
directing a laser beam having a wavelength such that the absorption of the laser energy by the substrate is less than approximately 60% and the wavelength being absorbed by the at least one conductive layer such that directing the laser beam along a selected path selectively patterns the at least one conductive layer for forming an electrically conductive array.

14. The method of claim 13, wherein a first conductive layers is a drive layer and the second conductive layer is a sense layer.

15. The method of claim 13, wherein directing the laser beam comprises laser patterning the drive and sense layer substantially simultaneously.

16. The method of claim 13, wherein directing the laser beam comprises laser patterning the drive and sense layers sequentially.

17. The method of claim 13, wherein conductive layers comprise a silver nanowire conductive material coating.

18. The method of claim 13, wherein said laser beam is configured with a wavelength in the range of approximately 0.7 μm to 7 μm.

19. An electrically conductive touch sensor panel construction configured for subsequent laser patterning, the panel construction comprising an integrally formed substrate having a first and a second electrically conductive layer thereon and wherein the first and second conductive layer are adhered in position prior to laser patterning and having a protective liner adhered to each side of the substrate having the electrically conductive layers thereon such that subsequent laser patterning is completed with the protective liner adhered to the panel construction and provides an electrically conductive array being in alignment and having registration within approximately 75 microns or less.

20. The panel construction of claim 19, and further comprising a first and second routing electrode, wherein the first routing electrode is in direct contact with the first conductive coating and the second routing electrode is in contact with the second conductive coating.

21. The panel construction of claim 20, and further comprising a first and a second adhesive layer wherein the first adhesive layer is in direct contact with the first routing electrode and the second adhesive layer is in direct contact with the second routing electrode.

22. The panel construction of claim 21, wherein each of the adhesive layers is in contact with a hard coat protective layer.

23. The panel construction of claim 19, wherein the first and second conductive layer are simultaneously laser processed to form corresponding electrical pattern arrays wherein a laser for laser processing is configured to selectively terminate conductive paths of the conductive coatings without compromising the substrate or protective liner.

24. The panel construction of claim 19, wherein the first conductive layer is laser processed and the second conductive layer is subsequently laser processed to form an electrical pattern array wherein a laser for laser processing is configured to selectively terminate conductive paths of the conductive coatings without compromising the substrate or protective liner.

25. The panel construction of claim 19, wherein the conductive coatings comprise a silver nanowire conductive material and a binder.
